(19) United States
(12) Patent Application Publication
(10) Pub. No.: US 2007/0089387 A1
(43) Pub. Date: Apr. 26, 2007

(54) Device for removing odor & air particulates from the air

(76) Inventor: Amando C. Ramos, Sacramento, CA (US)

Correspondence Address: AMANDO C. RAMOS, 7907 Neyland Way, Sacramento, CA, 95829, US

(21) Appl. No.: 11/522,209

(22) Filed: Sep. 15, 2006

Related U.S. Application Data
(60) Provisional application No. 60/730,556, filed on Oct. 25, 2005.

(51) Int. Cl. B01D 46/00

(52) U.S. Cl. 55/505

(57) ABSTRACT

A device for removing odor and air particulates from the air comprising: a filter housing (10) wherein a plurality of filter element supports (36) stand on said filter housing (10) floor spaced end-to-end and side-to-side leaving open spaces (38) around and above them; a filter element (40) rests on top of said filter element supports (36); a filter housing cover (12) having sufficient air inlet holes (28) facilitating air flow through said filter element (40) and into said open spaces (38); an air supply hose (14) connects said filter housing (10) to air supply tubes (20) via connector (24); a sliding coupler (22) holds said air supply tubes (20) together facilitating adjustment of loop size formed by said air supply tubes (20) by sliding said coupler (22); the other ends of said air supply tubes (20) are connected to filtered air duct (16) via its air duct inlet nipples (32); a sealing pad (18) is mounted onto filtered air duct (16) by inserting filtered air leads (30) into clearance holes (42) of said sealing pad (18).

### BACKGROUND

### Field of the Invention

This invention relates to a device for screening out odor, dust, and other contaminant particulates from the atmospheric air, specifically to such a unit that is particularly designed and intended for personal use in cleaning and filtering the air suitable for breathing by an individual human.

### OBJECTS AND ADVANTAGES

Accordingly, several objects and advantages of my invention, a device for removing odor, dust, and other contaminant particulates from the atmospheric air are as follows:
a) to provide a device for removing odor, dust, and other air particulates from the air, said device being specifically a personal air filter that is capable of screening out such air contaminants and pollutants, and delivering fresh clean air suitable for healthy breathing by an individual user.
b) to provide a personal air filter that protects an individual user from the health hazards associated with inhaling second-hand smoke in a cigarette smoke-laden environment.
c) to provide a personal air filter that may be used by asthmatics and people with other respiratory problems when exposed to air pollutants indoor or outdoor that trigger allergic reactions to such air contaminants and allergens.
d) to provide a personal air filter that can protect the health of employees and guests in a smoke-laden environment such as in casinos, bars, and gambling houses.
e): to provide a personal air filter that is easy to wear and can be inconspicuously worn under the user's garment without loss of its effectiveness.
f) to provide a personal air filter with removable filter element that may be replaced with a fresh new one when needed to assure a continuously efficient filtering and cleaning of the air for healthy breathing.
e) to provide a personal air filter that can contribute immensely to the reduction of the incidence of hypertension, heart disease, cancer in the lungs, the throat, and other vital organs, as well emphysema and other related respiratory diseases.
f) to provide a personal air filter that can help the citizens and the government save lives as well as billions of dollars that would otherwise be spent to cure and rehabilitate the people who fell victims of the ill effects of second hand smoke.

Further objects and advantages will become apparent from a consideration of the ensuing drawings and description.

### DRAWING FIGURES

In the drawings, the closely related figures have the same number but with different alphabetic suffixes.

FIG. 1A-Shows the isometric view of the invention

FIG. 1B-Shows the isometric exploded view of the invention.

FIG. 2A-Shows the isometric view of an alternative version of the air filter components

FIG. 2B-Shows the cut-out (sectionalized) view of the alternative filter housing

FIG. 3A-Shows the isometric view of an alternative embodiment of the invention

FIG. 3B-Shows the isometric cut-away view of the alternative embodiment of the invention.

FIG. 3C-Shows the isometric exploded view of the alternative embodiment of the invention

### REFERENCE NUMERALS IN THE DRAWINGS

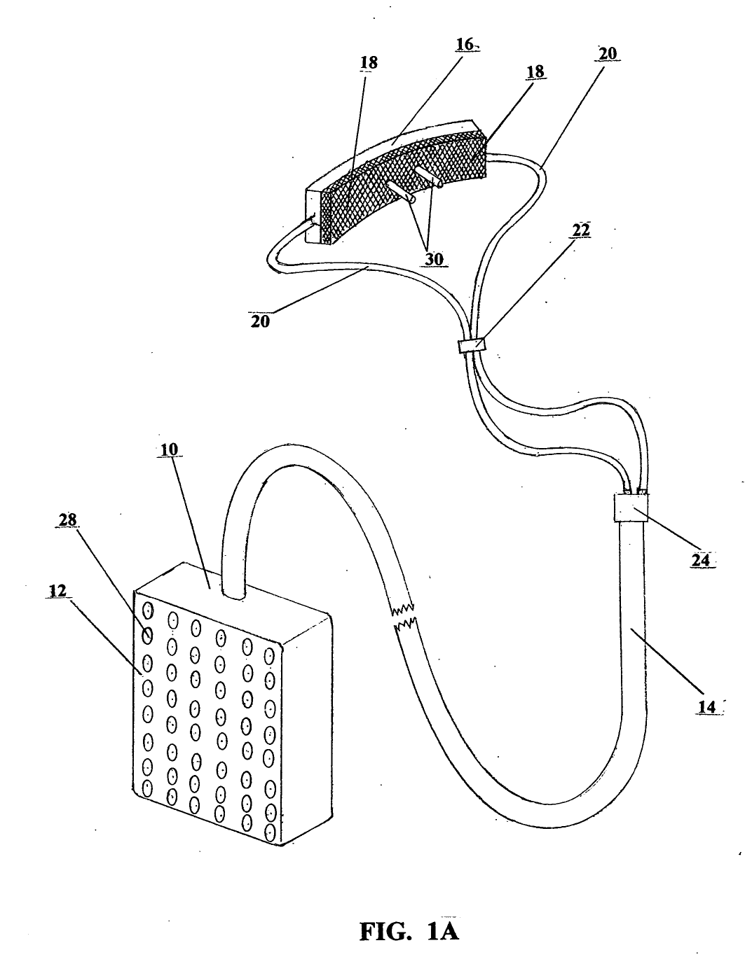

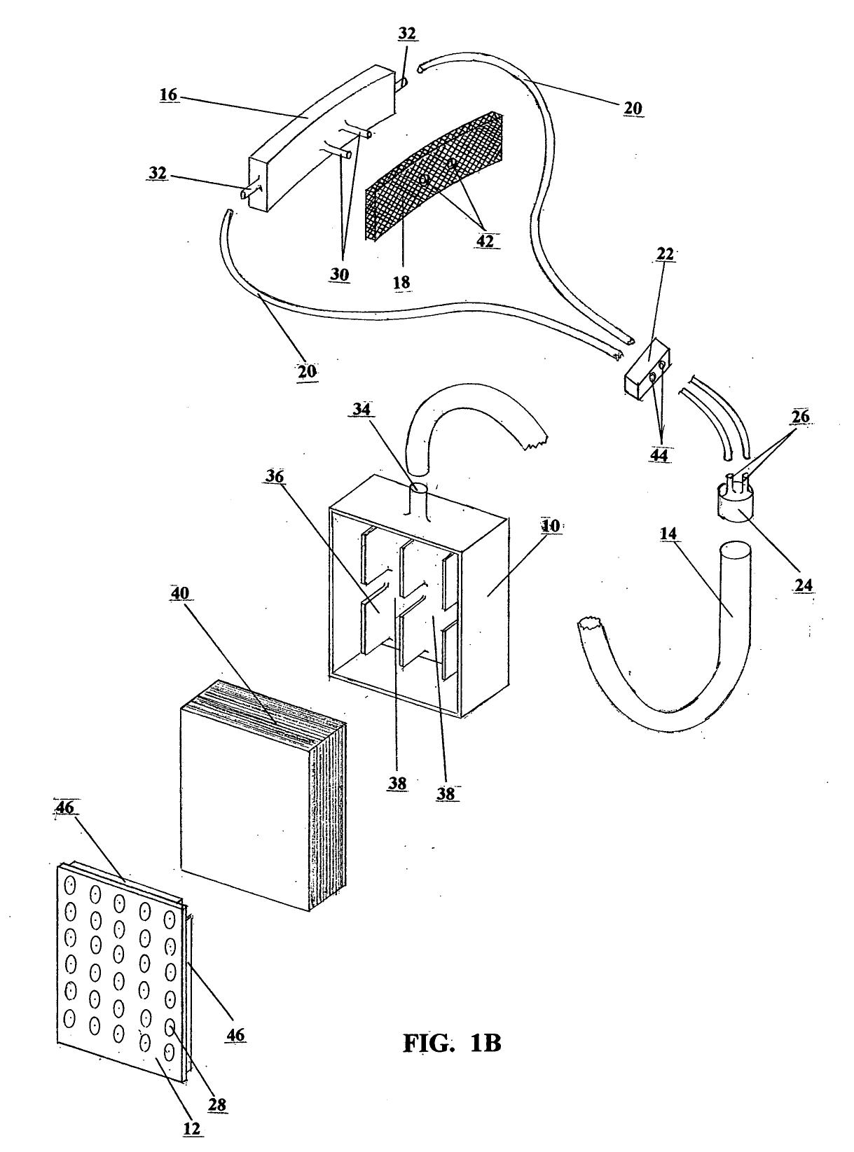

Referring to FIG. 1B:
10 Filter housing
12 Filter housing cover
14 Air supply hose
16 Filtered air duct
18 Sealing pad
20 Air supply tubes
22 Sliding coupler
24 Connector
26 Connector outlets nipples
28 Air inlet holes on the filter cover
30 Filtered air leads
32 Air duct inlet nipples
34 Air filter outlet
36 Filter element supports
38 Filtered air chamber
40 Filter element
42 Pad clearance holes
44 Coupler clearance holes
46 Filter cover tabs

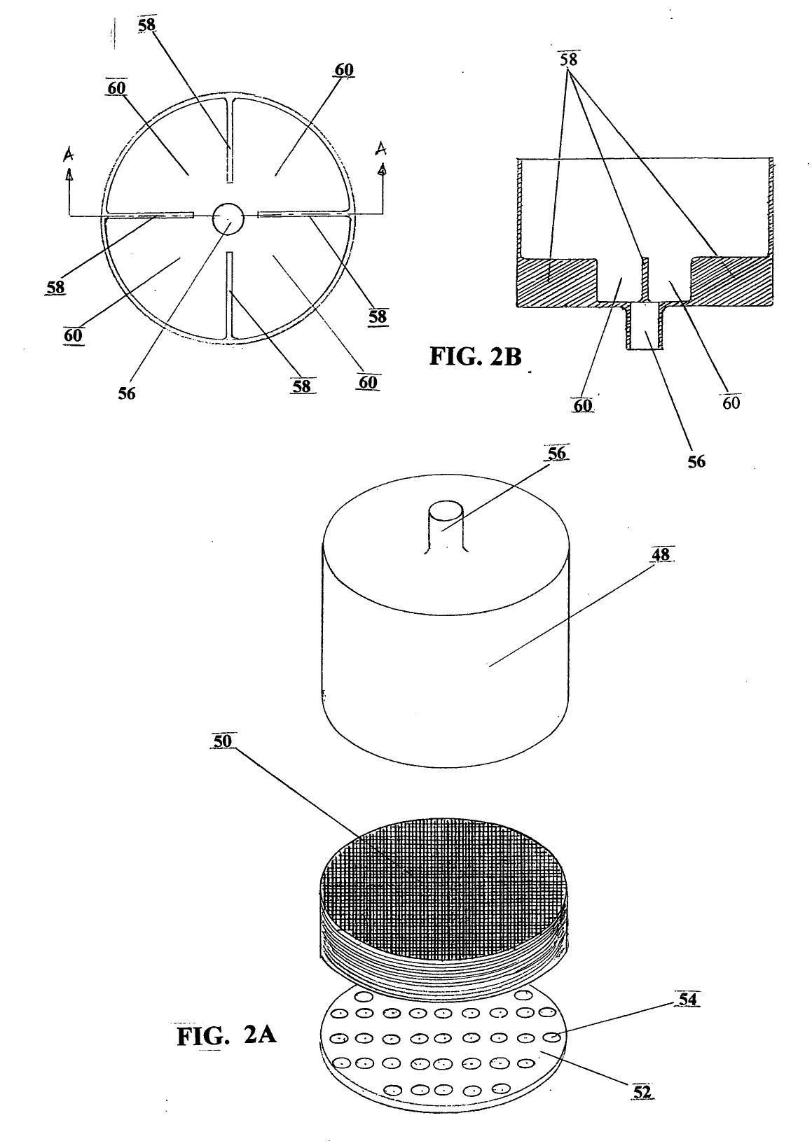

Referring to FIG. 2A:
48 Alternative version of the filter housing of the invention
50 Alternative version of the filter element of the invention
52 Alternative version of the filter housing cover of the invention
54 Air inlet holes of said alternative version of said filter housing cover of the of the invention
56 Air filter outlet of said alternative version of said filter housing of the invention

Referring to FIG. 2B:
58 Filter element supports in said alternative version of said filter housing of the invention
60 Filtered air chamber in said alternative version of said filter housing of the invention.

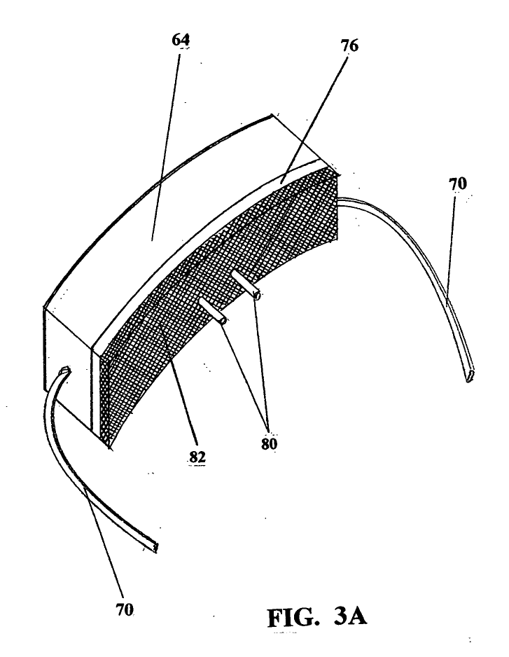

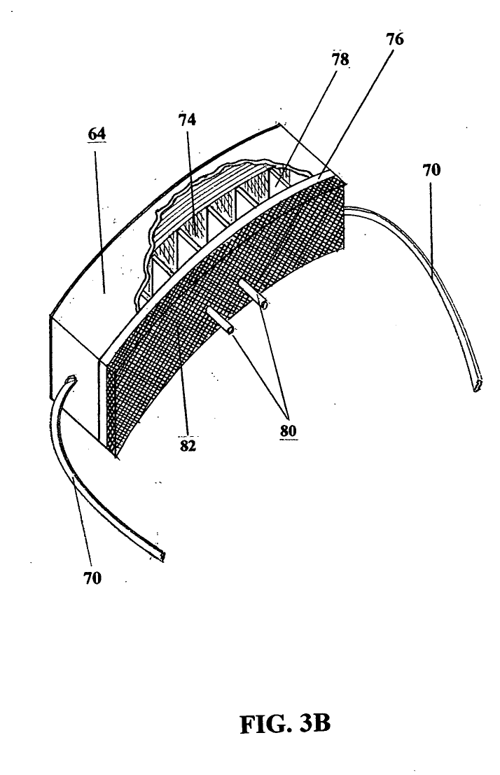

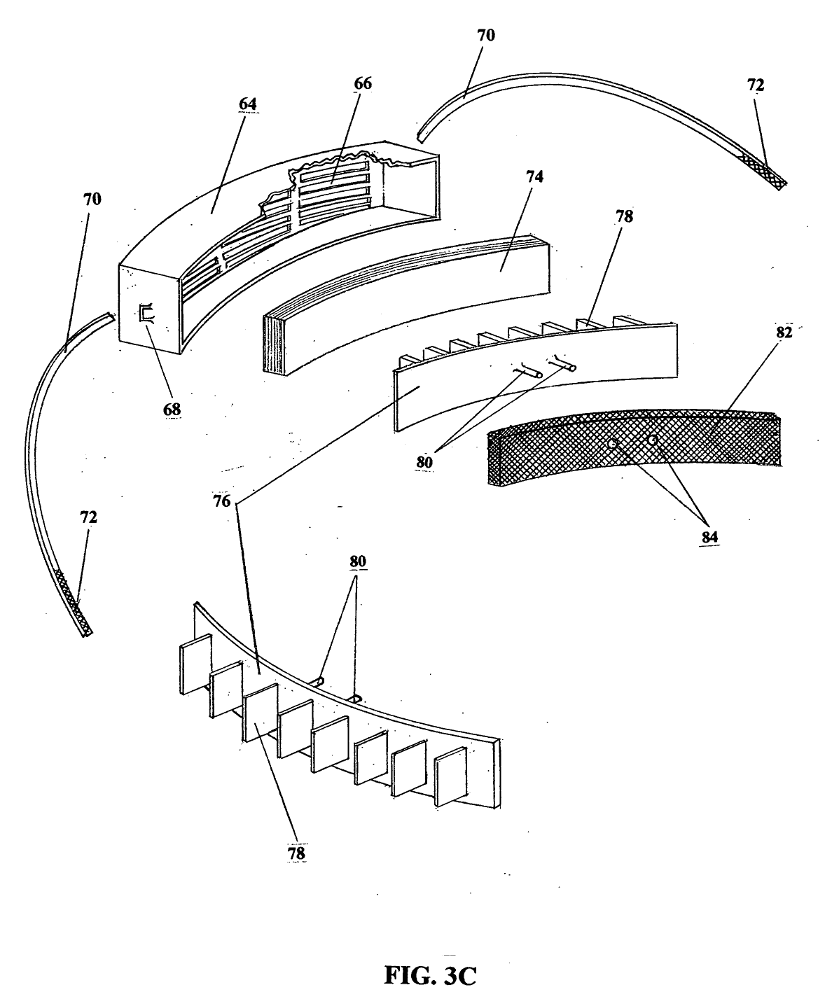

Referring to FIG. 3C:
64. Filter housing of an alternative embodiment of the invention.
66. Air inlet slits on said filter housing of said alternative embodiment of the invention.
68. Ear loops on said filter housing of said alternative embodiment of the invention.
70. Straps hooked into said ear loops of said alternative embodiment of the invention.
72. Velcro fastening strips at the ends of said straps of said alternative embodiment of the invention.
74. Filter element of said alternative embodiment of the invention.
76. Filter housing cover of said alternative embodiment of the invention.
78. Filter element supports on said filter housing cover of said alternative embodiment of the invention.
80. Filtered air leads on said filter housing cover of said alternative embodiment of the invention.
82. Sealing pad of said alternative embodiment of the invention.
84. Clearance holes on said sealing pad of said alternative embodiment of the invention.

### SUMMARY OF THE INVENTION

The device for removing odor and air particulates from the air of this present invention provides a reliable and effective means of screening out odor, dust and other air pollutants and contaminants from the atmospheric air yielding a healthy fresh clean air for a human to breath in. Said device of this invention which is specifically a personal air filter, comprises a filter housing which houses a filter element. A cover perforated with sufficient number of circular holes to effect an entry of maximum amount of atmospheric air covers the filter housing. One end of an air supply hose of predetermined diameter and length is connected to the outlet of the filter housing and the other end is fitted with a connector with two outlet nipples. An air supply tubing of smaller diameter than the air supply hose is connected to each of the outlet nipples of the said connector fitted at the end of the air supply hose. A sliding coupler is fitted onto the two supply air tubings that are connected to the outlet nipples of the connector. The other ends of the two air supply tubings are then connected to the air duct inlets of the air duct A sealing pad with two appropriately sized and properly situated clearance holes is fitted onto the two filtered air leads of, and is firmly seated against the filtered air duct.

Further description of the unique features, configuration, and advantages of the present invention will be apparent in the remaining text of the specification and the ensuing claims.

### DESCRIPTION OF THE PREFERRED EMBODIMENT OF THE INVENTION

The inventor's preferred embodiment of this invention, a device for removing odor and air particulates from the air, specifically a personal air filter, is depicted in FIG. 1A (isometric view) and FIG. 1B (isometric exploded view). Said personal air filter device comprises a filter housing 10 of appropriate dimension and having a predetermined cross sectional shape. Said filter housing has a plurality of filter element supports 36 appropriately dimensioned and properly spaced so as to create ample open spaces around them which constitute the filtered air chamber 38. Said filtered air chamber 38 is intended to function as a surge area for the filtered air to accumulate which the user of the device can draw (breath) air from. When the air is drawn (breathed) by the user from the air chamber 38, a partial vacuum is thus created in said air chamber 38 causing the outside atmospheric air to be sucked in and rush through the filter element and into the filtered air chamber 38 facilitating effortless and easy breathing for the user. A cylindrical elongated air filter outlet 34 protrudes on one side of the filter housing 10. A multi-layered or porous solid filter element 40 of predetermined cross sectional shape fits snugly into the filter housing 10 so as not to allow leakage around it of the outside atmospheric (unfiltered) air. Said filter element 40 sits on, and is supported by the filter element supports 36 which prevent the filter element 40 from moving down any farther thus maintaining the open space filtered air chamber 38. A filter housing cover 12 has a sufficient number of circular air inlet holes 28 that assures maximum amount of entry of outside atmospheric air through the filter element 40 and into the filtered air chamber 38. Said filter housing cover 12 also has a plurality of filter cover tabs 46 that facilitate tight fitting of the filter housing cover 12 onto the filter housing 10. An air supply hose 14 is connected to the filter housing 10 via air filter outlet 34. A connector 24 is fitted onto the other end of said air supply hose 14. Said connector 24 has two circular elongated connector outlets 26. An air supply tubing 20 is connected to each of the connector outlets 26 of the connector 24. A sliding coupler 22 with two appropriately sized clearance holes 44 is fitted onto said air supply tubings 20. The other ends of said air supply tubings 20 are each connected to the filtered air duct 16 via its air duct inlets 32. Said filtered air duct 16 has two air duct outlets 30 which are inserted into a user's nostrils an from which the user inhales the clean filtered air for breathing. A sealing pad 18 having two appropriately sized and properly situated clearance holes 42 is fitted onto the air duct outlet nipples 30 of, and is firmly seated against said filtered air duct 16.

Materials

Filter housing 10, filter housing cover 12, and filtered air duct 16 of the preferred embodiment of the invention may be made of injection molded ABS plastic or similar material. However, said component parts of the invention may be made of other materials such as PVC, lexan, fiberglass, aluminum, or other appropriate combination thereof. Filter element 40 may be made of cut-to-size hygienic fabric and layered to a predetermined thickness that allows efficient smooth flow of outside atmospheric air through it and into the filtered air chamber 38. Said filter element 40 may also be made of soft porous foam, or any appropriate paper material as well as the material used in filter cigarettes. Air supply hose 14 and air supply tube 20 may be made of rubber, polypropylene, or any other suitable rubberized material of hygienic or medical grade. Sealing pad 18 may be made of suitable hygienic-grade soft foam, soft rubber, or fabric material.

Shape and Dimension

Filter housing 10 of this preferred embodiment of the invention, a device for removing odor and air particulates from the air, specifically a personal air filter, is rectangular in shape and hence also do its sub-components filter element 40 and filter housing cover 12. Said filter housing 10 measures about 2 inches long×1½ inches wide×⅞ inch thick. Filter element 40 and filter housing cover 12 are therefore appropriately dimensioned accordingly to properly fit into filter housing 10. Filtered air duct 16 is a rectangular parallelopipe having appropriate curvature to fit the contour of a human nose. Sealing pad 18 is rectangular in shape and flexible enough to follow the curvature of filtered air duct 16. Filtered air duct 16 measures about 1¾ inches long×⅞ inch wide×½ inch thick. Sealing pad 18 has a dimension of 1¾ inches long×⅞ inch wide×⅛ inch thick. Air supply hose 14 about ⅜ inch in diameter and about 12 inches to 15 inches long. Air supply tube 20 about ⅛ inch in diameter and about 16 inches long.

Above stated dimensions of the various components of the invention a device for removing odor and air particulates from the air, specifically a personal air filter, are only intended to give the reader an idea of the approximate physical size of said various component parts of the invention and of the unit as a whole and should not therefore be construed as limitations of the scope of this invention.

Production

FIG. 1B shows the isometric exploded view of the invention a device for removing odor and air particulates from the air, specifically a personal air filter. It can be seen from said isometric exploded view (FIG. 1B) of the invention that once the various component parts have been fabricated to specified configuration and dimension, the process of assembling said various components into a finished product is as simple as following the graphical instruction depicted on said isometric exploded view shown in FIG. 1B. The production of the various component parts of the invention personal air filter is as follows: Filter housing 10 and its lid filter housing cover 12 are produced by plastic injection molding process. As each of said components filter housing 10 and filter housing cover 12 is ejected by a molding machine, it is completely finished and ready for assembly. Filter element 40 is fabricated by cutting an appropriate hygienic fabric material into a predetermined size and stacking them in layer to a specified thickness. The completed filter element 40 is then fitted into filter housing 10 and filter housing cover 12 is then snapped on in place to complete a unit of an air filter assembly. Air supply hose 14 is cut to a predetermined length and then connected to said completed air filter assembly via its air filter outlet 34. A connector 24 which is also produced by plastic injection molding process is then fitted onto the other end of said air supply hose 14. Two pieces of air supply tubes 20 cut to specified lengths are cut from an appropriate hygienic rubberized material or polypropylene. One end of each of said air supply tubes 20 is connected to each of connector outlet nipples 26 of said connector 24. The other two ends of said air supply tubes 20 are inserted through two corresponding coupler clearance holes 44 of sliding coupler 22. The two ends of air supply tubes 20 are then each connected to filtered air duct 16 via its air duct inlet nipples 32. Sealing pad 18 is then mounted onto filtered air duct 16 by inserting filtered air leads 30 of said filtered air duct 16 into pad clearance holes 42 of said sealing pad 18. Assembly of the invention, a device for removing odor and air particulates from the air, specifically a personal air filter is thus completed as depicted in FIG. 1A.

### OPERATION OF THE PREFERRED EMBODIMENT OF THE INVENTION

Operation or use of the preferred embodiment of this invention a device for removing odor and air particualtes from the air, specifically a personal air filter is simple, easy and pretty straight forward. To use a completed assembly of this invention, a personal air filter, a user needs only to do the following 7 simple steps: (1) slide sliding coupler 22 away from filtered air duct 16 and towards connector 24 just as far enough as to allow room for the user's head to get into the loop formed by the two air supply tubes 20 including filtered air duct 16 between them. (2) with the air filter component assembly in front of; and touching the user's chest or stomach area, insert user's head into the said loop described in step (1) above so that filtered air duct 16 is at the back of the user's neck with the filtered air leads 30 of said filtered air duct 16 are pointing towards the back of the user's neck. (3) swing the filtered air duct 16 over the user's head towards the front of his face so that each of the air supply tubes 20 rides over the back of each of the user's ears. (4) position filtered air duct 16 on the user's nose so that filtered air leads 30 are comfortably inserted into the user's nostril. (5) slide the sliding coupler 22 towards the user's neck to tighten the loop described in step (1) above and to secure filtered air duct 16 in place on the user's nose with sealing pad 18 comfortably pressing against the user's nose and sufficiently sealing the contact area between said sealing pad 18 and the user's nose. (6) insert filter housing 10 inside the user's garment so that said filter housing 10 rests on the user's chest or stomach area with the perforated side of the filter housing cover 12 of said filter housing 10 facing towards the front of, and away from the user's chest or stomach area. (7) the user can now then breath clean filtered air by inhaling through his/her nose and exhaling through his/her mouth.

The invention, a device for removing odor and air particulates from the air, specifically a personal air filter will be sold as a kit which includes a number of replacement filter element 40 and sealing pad 18. The user then may replace filter element 40 and/or sealing pad 18 as deemed necessary.

### CONCLUSION, RAMIFICATIONS, AND SCOPE OF THE INVENTION

Accordingly, the reader will see that the invention, a device for removing odor and air particulates from the air, specifically a personal air filter is very handy, simple to use, and extremely effective in screening out odor, pollutants and other contaminants from the atmospheric air and providing healthy clean air for breathing by a human. Additionally, due to its physical dimension, the invention is very portable and remarkably light in weight. Further advantages of this invention are as follows:
a) This invention may be used by the people not only for preventing inhalation of smoke-laden air in enclosed areas such as casinos, bars, and gambling houses, but wherever the user goes where dust, foul odor, and other pollutants are present in the surrounding air.
b) This invention could immensely improve the quality of life of asthmatics and other people with other respiratory problems for now they can go out and enjoy outdoor life without fear of breathing difficulties triggered by allergens in the air.
c) This invention may possibly be used for the administration of a certain medication (with the approval of the user's physician) that needs to be inhaled periodically, by soaking the unit's filter element 40 in a predetermined amount of the applicable medication.

Although the above description cites many specificities, they should not be construed as limitations on the scope of the invention, but rather as an exemplification of one preferred embodiment thereof. There are possible variations of said preferred embodiment of this invention. For example, filter housing 10 in FIG. 1B may be made into a cylindrical shaped filter housing 48 as shown in FIG. 2A, and filter element 40 and filter housing cover 12 in FIG. 1B may take a circular shape (reference numerals 50 and 52 respectively) as shown in FIG. 2A. Furthermore, the round air inlet holes 54 on filter housing cover 52 on FIG. 2A may be changed to long slits cut horizontally across the surface of said filter housing cover 52.

An alternative embodiment of this invention is shown on FIG. 3A. Note that except for the filtered air duct 16 component of this invention shown on FIG. 1B, all the other components such as air supply tubes 20, sliding coupler 22, connector 24, air supply hose 14, filter housing 10, filter element 40, and filter housing cover 12 have been eliminated and the only remaining component, the filtered air duct 16 on FIG. 1B has been enlarged thereby converting it into filter housing 64 of said alternative embodiment of the invention as shown on FIG. 3B. Said enlarged filter housing 64 can now accommodate and incorporate within it filter element 74. The isometric exploded view of this alternative embodiment (now a compact version) of the invention is shown on FIG. 3C Filter housing 64 is a curved parallelopipe with one of its sides open and of which opposite side having a plurality of long air inlet slits 66. Each end of said filter housing 64 has an ear loop 68 to where a strap 70 is attached. The free ends of said straps 70 have velcro or other fastening means which facilitates joining said ends of said straps 70 when wrapped around the user's head to secure the air filter unit in proper position on the user's nose. Filter element 74 having a predetermined cross sectional shape fits snuggly inside filter housing 64 facilitating an air-tight contact with said filter housing 64 inside wall surfaces precluding seepage of outside atmospheric air. Filter housing cover 76 has a plurality of filter element supports 78 on is convex side. Filter housing cover 76 further having a plurality of filtered air leads 80 on its concave side that would fit into the nostrils of the user through which said user would breath in the clean filtered air. Filter housing cover 76 snaps in onto said filter housing 64 enclosing said filter element 74 within said filter housing 64. Sealing pad 82 having a predetermined cross sectional shape and further having a plurality of round clearance holes 84 is mounted onto and glued to the concave side of said filter housing cover 76 of which filtered air leads 80 go through said pad clearance holes 84 of said sealing pad 82. Said sealing pad 82 facilitates comfortably soft and air-tight contact of the personal air filter unit with a user's nose. The resulting product will be literally an ultimately compact personal air filter as shown on FIG. 3A.

Anyone skilled in the art will acknowledge the fact that the preferred embodiment of the invention disclosed herein can occur in various forms, shapes, and detail without deviating from the true essence and spirit of the invention. Accordingly, the scope of this invention should be determined by the appended claims and their legal equivalents rather than by the embodiment described herein.

I claim:

1. A device for removing odor, air particulates, and other contaminants from the atmospheric air, said device being comprised of:
a multi-sided container having a predetermined cross-sectional shape and having a plurality of vanes standing vertically on its floor surface. Said vanes having a predetermined length, width, and height and are spaced from each other end-to-end and side-to-side at predetermined distances such that open spaces exist around and above said vanes. Said multi-sided container further having a cylindrical projection with specified length and diameter on one of its sides.
a screening medium having a predetermined cross-sectional shape and appropriately dimensioned to fit snuggly into said multi-sided container and seated on top of said vanes that are standing vertically on the floor surface of said multi-sided container. Said screening medium is designed to remove odor, air particulates, and other contaminants from the atmospheric air.
a flat closure having a pre-determined cross-sectional shape and appropriately dimensioned to snap onto, and provide an air-tight seal in enclosing above said screening medium in above said multi-sided container.
an elongated flexible tubular member having a specified length and diameter is connected to above said multi-sided container through its said cylindrical projection on one of its sides.
a connecting member having a cylindrical cross section with one end closed and having a specified length and diameter, and further having a plurality of cylindrical projections at said closed end of said connecting member. Said cylindrical projections having a specified length and diameter.
a plurality of smaller-diameter elongated flexible tubular members having a specified length and diameter the first ends of which are connected to said cylindrical projections at the closed ends of above said connecting member
a coupling member having a predetermined cross-sectional shape and having a plurality of through holes of specified diameter.
a hollow parallelopipe member having a predetermined cross sectional shape and having both of its ends closed. Said hollow parallelopipe member also having a predetermined curvature and further having a cylindrical projection with specified length and diameter on each of its closed ends.
a flexible cushioning member having a pre-determined cross-sectional shape and having a plurality of through holes situated at a pre-determined location on the wider side of said flexible cushioning member.

2. The multi-sided container of claim 1 is a box-shaped filter housing having a rectangular cross section. The vanes of claim 1 that are standing on the floor of said filter housing are filter element supports, and said open spaces around said filter element supports constitute an air chamber that serves as a surge area for the filtered air. The cylindrical projection of claim 1 on one side of said filter housing is an air filter outlet through which the filtered air goes out and flows through the elongated flexible tubular member of claim 1 as the user of the device breathes in said filtered air.

3. The screening medium of claim 1 is a filter element that is placed inside said filter housing of claim 2 and which rests on top of said filter element supports of claim 2 thus creating said air chamber below it and around said filter element supports.

4. The flat closure of claim 1 is an air filter housing cover having a pre-determined number of circular air inlet holes that facilitate the maximum flow of outside atmospheric air through said filter element of claim 3 and into said air chamber of claim 3. Said filter housing cover further having tab of specified length and height at each edge on the inside surface of said filter housing cover. Said tabs allow said filter housing cover to be snapped onto said filter housing for an air-tight fitting of said filter housing cover.

5. The elongated flexible tubular member of claim 1 is an air supply hose one end of which is connected to said filter housing of claim 2 via said air filter outlet of claim 2.

6. The connecting member of claim 1 is a connector having a couple of connector outlet nipples termed as cylindrical projections in claim 1. Said connector is attached to the other end of said air supply hose of claim 5.

7. The coupling member of claim 1 is a sliding coupler having a couple of clearance holes of pre-determined diameter and properly situated on the wider side of said sliding coupler.

8. The plurality of smaller-diameter elongated flexible tubular members of claim 1 are the air supply tubes of which two ends are inserted through said clearance holes of said sliding coupler of claim 7 and which same ends are connected to said connector outlet nipples of claim 6.

9. The hollow parallelopipe member of claim 1 is a filtered air duct wherein said plurality of cylindrical projections on one of the wider sides of said filtered air duct are filtered air leads. Additionally, the cylindrical projections of claim 1 on each end of said filtered air duct are air duct inlet nipples. The other ends of said air supply tubes of claim 8 are connected to said air duct inlet nipples of said filtered air duct.

10. The flexible cushioning member of claim 1 is a sealing pad having two clearance holes into which said filtered air leads of claim 9 are inserted to mount said sealing pad onto said filtered air duct of claim 9.
Whereby the invention, a device for removing odor and air particulates from the air, specifically, a personal air filter, provides a conveniently portable device for effectively screening out odor, dust and other pollutants from the atmospheric air yielding fresh clean healthy air for breathing by a human.
